(19) United States
(12) Patent Application Publication
(10) Pub. No.: US 2025/0354407 A1
(43) Pub. Date: Nov. 20, 2025

(54) DOOR LOCK AND REFRIGERATOR

(71) Applicant: QINGDAO HIRON COMMERCIAL COLD CHAIN CO., LTD., QINGDAO (CN)

(72) Inventors: Hongkui MA, QINGDAO (CN); Long GAO, QINGDAO (CN); Peng WAN, QINGDAO (CN); Zhengfang LI, QINGDAO (CN); Yongjie XU, QINGDAO (CN); Liyun WANG, QINGDAO (CN)

(21) Appl. No.: 18/933,911

(22) Filed: Oct. 31, 2024

(30) Foreign Application Priority Data
May 16, 2024 (CN) 202410608500.7
May 16, 2024 (CN) 202410608503.0
May 16, 2024 (CN) 202410608505.X
May 16, 2024 (CN) 202421069433.8
May 16, 2024 (CN) 202421069466.2
May 16, 2024 (CN) 202421069494.4

(51) Int. Cl. E05B 9/02; E05B 65/00

(52) U.S. Cl. CPC E05B 9/02; E05B 65/0042; E05Y 2900/31

(57) ABSTRACT

A door lock and a refrigerator equipped with the door lock. The door lock includes a lock hook and a lock body; the lock body includes a lock housing and a partition arranged inside the lock housing, the partition divides the internal space of the lock housing into a lock core area and a lock hook connection area, the partition is provided with a through hole connecting the lock core area and the lock hook connection area; the lock housing is provided with a lock opening connected to the lock hook connection area; a latch bolt and a driving element are installed in the lock core area, the driving element drives the latch bolt to perform linear reciprocating motion between a locked position and an unlocked position.

### CROSS-REFERENCE TO RELATED APPLICATION

The present application claims priorities to Chinese Patent Application No. 202410608503.0 filed on May 16, 2024, Chinese Patent Application No. 202410608505.X filed on May 16, 2024, Chinese Patent Application No. 202410608500.7 filed on May 16, 2024, Chinese Patent Application No. 202421069494.4 filed on May 16, 2024, Chinese Patent Application No. 202421069433.8 filed on May 16, 2024, Chinese Patent Application No. 202421069466.2 filed on May 16, 2024, which are hereby incorporated by reference in their entireties.

### TECHNICAL FIELD

The present application belongs to the technical field of refrigeration and freezing equipment, and in particular relates to a door lock and a refrigerator.

### BACKGROUND ART

In modern retail environments, unmanned vending smart refrigerators are widely used because of their convenience and efficiency. Smart refrigerators are usually equipped with door locks to ensure that the door can be automatically locked after shopping to prevent the loss of goods. However, the current technical problems of smart refrigerators are mainly lie in the door locks.

Usually, the door lock is installed on the light box on the top of the refrigerator, which is outside the refrigerator. The position of the door lock is conspicuous and exposed, it is easily vandalized or accidentally damaged, which compromises the security. Additionally, to install the door lock, the refrigerator must be equipped with a light box on the top, which increases the manufacturing cost of the refrigerator.

However, if the door lock is installed inside the refrigerator to avoid human damage, new problems arise. There is usually a certain amount of moisture inside the refrigerator, especially when the door is frequently opened and closed, the moisture content will be higher. Since most door locks are designed as electronic locks, prolonged exposure of electronic components to moisture can easily result in corrosion or short circuits, causing the door lock to fail. In addition, moisture is easy to frost, and there is a problem that the latch bolt is frosted and cannot be unlocked.

Therefore, how to improve the security of door locks for smart refrigerators is a technical problem that urgently needs to be solved.

### SUMMARY

In view of at least one shortcoming in the prior art, the present application provides a door lock and a refrigerator.

A first aspect of the present application provides a door lock, comprising a lock hook and a lock body; the lock body comprises a lock housing and a partition provided inside the lock housing, the partition divides an internal space of the lock housing into a lock core area and a lock hook connection area, a through hole connecting the lock core area and the lock hook connection area is formed on the partition; a lock opening connected to the lock hook connection area is formed on the lock housing, allowing the lock hook to extend into or retract from the lock hook connection area; a latch bolt and a driving element are provided in the lock core area, and the driving element is configured to drive the latch bolt to perform a linear reciprocating motion between a locked position and an unlocked position.

A second aspect of the present application provides a refrigerator, comprising a refrigerator body and a door disposed on the refrigerator body, a storage compartment is defined inside the refrigerator body, and a door lock described in the first aspect is arranged between the refrigerator body and the door, wherein the lock body is installed on the refrigerator body and is located on an inner wall of the refrigerator body facing the storage compartment, and the lock hook is correspondingly installed on the door.

### BRIEF DESCRIPTION OF THE DRAWINGS

FIG. 1a is a first schematic diagram of a door lock provided in some embodiments of the present application;

FIG. 1b is a second schematic diagram of the door lock provided in some embodiments of the present application;

FIG. 1c is a third schematic diagram of the door lock provided in some embodiments of the present application;

FIG. 2a is a cross-sectional view of the door lock provided in some embodiments of the present application when in a locked position;

FIG. 2b is a cross-sectional view of the door lock provided in some embodiments of the present application when in an unlocked position;

FIG. 3a is a first schematic diagram of a lock body in the door lock provided in some embodiments of the present application;

FIG. 3b is a second schematic diagram of the lock body in the door lock provided in some embodiments of the present application;

FIG. 4 is a schematic diagram of internal structure of the lock body in the door lock provided in some embodiments of the present application;

FIG. 5 is a partial enlarged view of an upper part of the lock body in FIG. 4;

FIG. 6 is a cross-sectional view of the lock body in the door lock provided in some embodiments of the present application;

FIG. 7 is a schematic diagram showing the connection between a sealing member and a partition in the door lock provided in the embodiment of the present application;

FIG. 8a is a first schematic diagram of the sealing member in the door lock provided in some embodiments of the present application;

FIG. 8b is a second schematic diagram of the sealing member in the door lock provided in some embodiments of the present application;

FIG. 9a is a first schematic diagram of a partition and a boss in the door lock provided in some embodiments of the present application;

FIG. 9b is a second schematic diagram of a partition and a boss in the door lock provided in some embodiments of the present application;

FIG. 10a is a first schematic diagram of a linkage member in the door lock provided in an embodiment of the present application;

FIG. 10b is a second schematic diagram of a linkage member in a door lock provided in some embodiments of the present application;

FIG. 11 is a schematic diagram of an electromagnet with a heating wire coiled around it in the door lock provided by some embodiments of the present application;

FIG. 12 is a schematic diagram showing the connection between a processor and a temperature sensor, a photoelectric sensor, a magnetic sensor, a RFID sensing module and a electromagnet in the door lock provided in some embodiments of the present application;

FIG. 13 is a schematic diagram of a refrigerator provided with the door lock according to some embodiments of the present application;

FIG. 14 is a schematic diagram of another refrigerator provided with the door lock according to some embodiments of the present application;

FIG. 15 is a schematic diagram showing the arrangement of an external lock and lock wires in the refrigerator provided in some embodiments of the present application;

FIG. 16a is a first schematic diagram of a T-shaped lock in the refrigerator provided in some embodiments of the present application;

FIG. 16b is a second schematic diagram of the T-shaped lock in the refrigerator provided in some embodiments of the present application;

FIG. 17 is a schematic diagram showing the installation position of a junction box in the refrigerator provided in some embodiments of the present application;

FIG. 18a is a perspective view of a refrigerator provided with a shielding part according to some embodiments of the present application;

FIG. 18b is a front view of the refrigerator provided with the shielding part according to some embodiments of the present application;

FIG. 18c is a partial enlarged view of the position of the shielding part in FIG. 18b;

FIG. 19 is a partial enlarged view of the position of a recessed handle of the refrigerator provided in some embodiments of the present application.

Wherein:
100, door lock; 200, refrigerator body; 2001, storage compartment; 300, door; 3001, door frame; 3002, viewing window; 3003, shielding part; 3004, control panel; 3005, recessed handle; 3006, light strip;
1, lock hook; 11, locking groove; 2, lock body; 21, lock housing; 21A, lock core area; 21A1, sealed area; 21A2, non-sealed area; 21B, lock hook connection area; 213, lock opening; 214, first side wall; 215, operation window; 216, sliding rail; 217, first baffle; 218, outlet hole; 22, partition; 221, through hole; 222, partition block; 23, latch bolt; 231, fixing groove; 24, driving element; 241, electromagnet; 242, coil of electromagnet; 25, sealing member; 251, first end of sealing member; 252, second end of sealing member; 253, mounting part; 254, limiting ring; 255, deformation part; 256, fixing part; 26, boss; 261, channel; 262, limiting groove; 27, linkage member; 271, operation panel; 272, driving plate; 273, toggle block; 274, sliding groove; 275, second baffle; 276, support plate; 2761, first support plate; 2762, second support plate; 28, linkage base; 281, linkage rod; 282, matching surface; 29, cover; 291, covering part; 292, assembly part;
3, control circuit board; 31, processor; 32, RFID sensing module;
4, latch bolt position monitoring assembly; 41, light-shielding member; 42, photoelectric sensor;
5, temperature sensor;
6, heating element; 61, heating wire;
7, light-emitting element;
8, door connector; 81, RFID chip;
9, lock hook in place monitoring assembly; 91, magnet; 92, magnetic sensor;
10, external lock; 101, T-shaped lock; 102, swing rod; 103, lock cylinder of T-shaped lock; 104, housing of T-shaped lock; 105, mounting hole; 106, latch bolt of external lock; 107, lock hole of external lock;
20, lock wire;
30, junction box; 301, wire hole; 302, wire holder; 303, wire groove.

### DETAILED DESCRIPTION OF EMBODIMENTS

The technical solutions in the embodiments will be described clearly and completely below with reference to the accompanying drawings. Apparently, embodiments to be described in the specific implementations are merely some but not all of the embodiments of the present application. Based on the embodiments of the present application, all other embodiments obtained by those of ordinary skill in the art without creative efforts shall fall within the protection scope of the present application. It should be noted that, in the description of the present application, directional or positional relationships indicated by terms such as “horizontal”, “vertical”, “upper”, “lower”, “top”, “bottom”, “inside”, “outside”, etc., are based on directional or positional relationships as shown in the accompanying drawings, and are only for the purposes of facilitating and simplifying the descriptions, rather than indicating or implying that the referred apparatus or element has to have a specific direction or be constructed and operated in the specific direction, and therefore, they cannot be regarded as limitations on the present application.

Terms “first” and “second” are for descriptive purposes only, and cannot be understood as indicating or implying the relative importance or implicitly indicating the number of indicated technical features. Therefore, features defined as “first” and “second” may explicitly or implicitly include one or more of the features.

In the description of the present application, it should be noted that unless otherwise specified and limited, the terms “mounted”, “linked” and “connected” should be broadly understood, for example, it means that two elements may be fixedly connected, detachably connected or integrally connected; may be directly connected, may be indirectly connected through an intermediate medium, or may be internally communicated. For those skilled in the art, the specific meanings of the above terms in this application can be understood depending on specific situations.

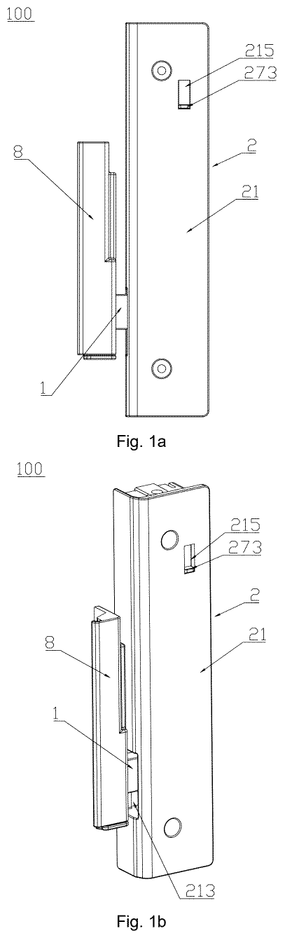

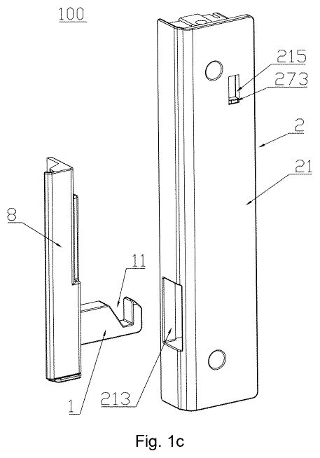

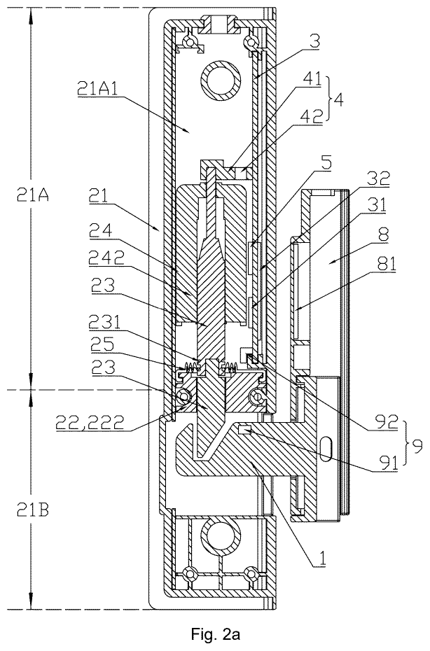

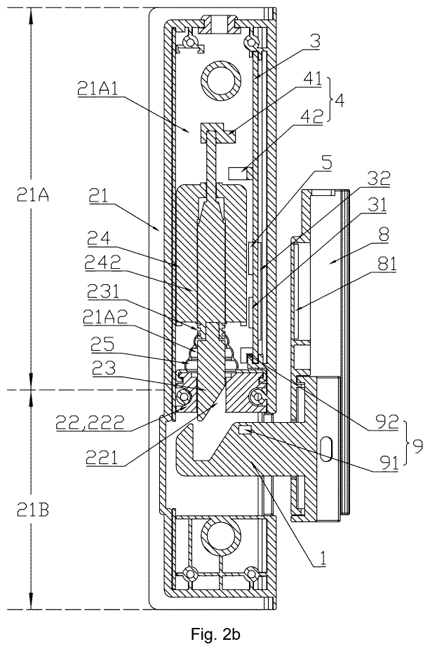

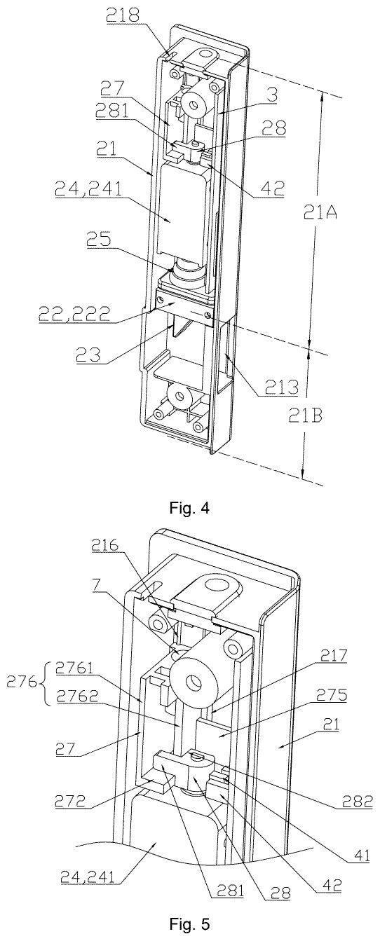

A first aspect of the present application provides a door lock 100. In some embodiments, as shown in FIGS. 1a to 4, the door lock 100 includes a lock hook 1 and a lock body 2; the lock body 2 includes a lock housing 21 and a partition 22 provided inside the lock housing 21, and the partition 22 divides an internal space of the lock housing 21 into a lock core area 21A and a lock hook connection area 21B, a through hole 221 connecting the lock core area 21A and the lock hook connection area 21B is formed on the partition 22; a lock opening 213 connected to the lock hook connection area 21B is formed on the lock housing 21, allowing the lock hook 1 to extend into or retract from the lock hook connection area 21B; a latch bolt 23 and a driving element 24 are provided in the lock core area 21A, and the driving element 24 drives the latch bolt 23 to perform a linear reciprocating motion between a locked position and an unlocked position. Specifically: as shown in FIG. 2a, the driving element 24 drives the latch bolt 23 to extend into the lock hook connection area 21B through the through hole 221 to lock with the lock hook 1, or, as shown in FIG. 2b, the driving element 24 drives the latch bolt 23 to return to the lock core area 21A to release the lock with the lock hook 1, achieving unlocking.

The door lock 100 further includes a control circuit board 3, which is equipped with a processor 31, and the processor 31 is electrically connected to the driving element 24; the processor 31 is configured to: when receiving a locking instruction, control the driving element 24 to drive one end of the latch bolt 23 to extend into the lock hook connection area 21B through the through hole 221 so as to lock with the lock hook 1; when receiving an unlocking instruction, control the driving element 24 to drive the latch bolt 23 to retract back into the lock core area 21A so as to unlock. The driving element 24 can drive the latch bolt 23 to move by electromagnetic or mechanical means.

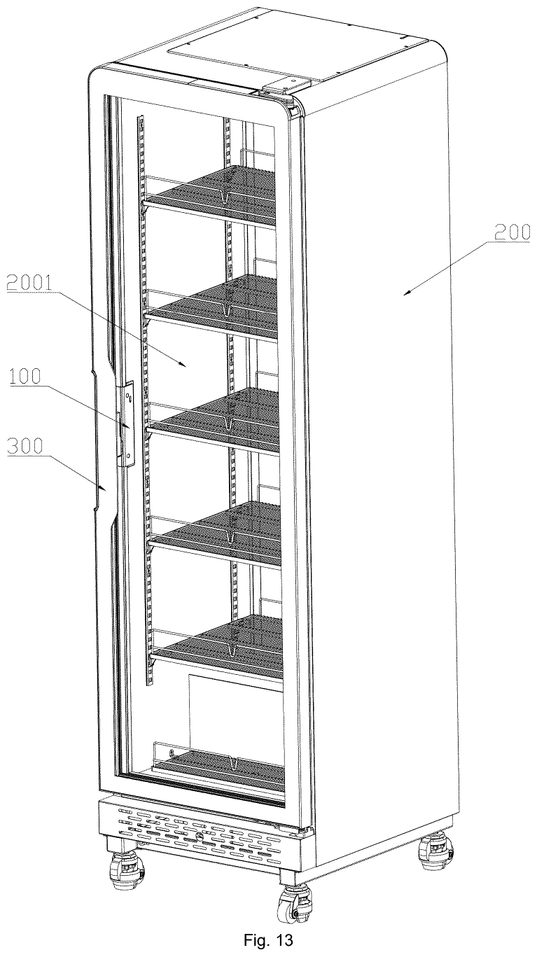

The door lock 100 provided in the aforementioned embodiments can be used in a refrigerator. For example, as shown in FIG. 13, the lock body 2 is installed inside the refrigerator body 200, and the lock hook 1 is installed on the door 300. In these embodiments, the internal space of the lock housing 21 is divided into the lock core area 21A and the lock hook connection area 21B by the partition 22, the lock core area 21A is used for accommodating various components and has relatively good independence, while the lock hook connection area 21B is connected to the outside. Since the lock core area 21A is separated from the lock hook connection area 21B by the partition 22, although the moisture inside the refrigerator body 200 may enter the lock hook connection area 21B, very little moisture can further enter the lock core area 21A, which can reduce the adverse effects of moisture on the components inside the lock core area 21A. In addition, the lock core area 21A and the lock hook connection area 21B are respectively located at the upper and lower parts of the lock housing 21, the latch bolt 23 performs a linear reciprocating motion in the vertical direction, while the lock opening 213 is formed on the side wall of the lock housing 21, and the lock hook 1 performs a linear reciprocating motion in the horizontal direction to extend into or retract from the lock hook connection area 21B. The through hole 221 connecting the lock core area 21A and the lock hook connection area 21B is staggered vertically and horizontally with the lock opening 213, so that they are not directly opposite to each other. Therefore, if moisture enters the lock hook connection area 21B through the lock opening 213, its flow direction needs to be changed in order to enter the lock core area 21A through the through hole 221. This increases the difficulty for moisture to enter the through hole 221, thereby reducing the probability of moisture freezing in the through hole 221 which may hinder the movement of the latch bolt 23.

Through the improvements made to the structure of the door lock 100 as described above, the door lock 100 can be installed inside the refrigerator body 200. When the door 300 is closed and locked, the lock body 2 is also locked inside the refrigerator body 200, avoiding the exposure of the lock body 2 and making it difficult to be damaged, thereby improving the security of the goods in the refrigerator. In addition, since the door lock 100 is installed inside the refrigerator body 200, there is no need to set up a light box to install the door lock 100, thereby reducing the cost. Furthermore, even if only one door lock 100 is set, good security can still be maintained, addressing the current issues of high cost and insufficient security of the door locks of smart refrigerators.

It can be understood that the lock hook 1 is provided with a locking groove 11, an opening of the locking groove 11 faces the direction of the latch bolt 23, and the latch bolt 23 can be inserted into the locking groove 11 to lock with the lock hook 1, or withdrawn from the locking groove 11 to realize unlocking. The partition 22 can be fixed inside the lock housing 21 by bolts, which allows for easy disassembly, so that the lock core area 21A can be opened to repair and replace the latch bolt 23 and other components, thereby improving the convenience of maintenance of the door lock 100.

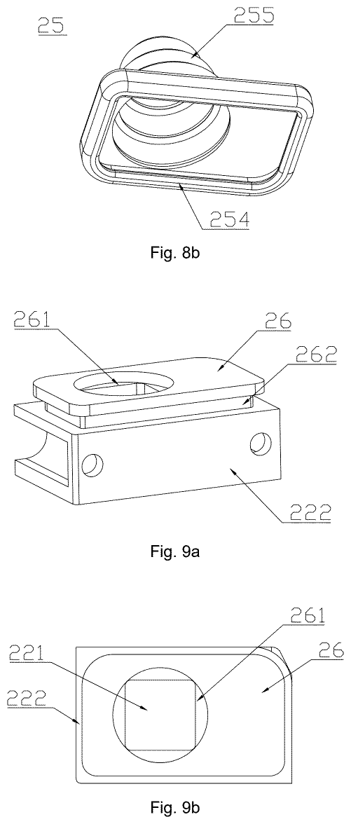

In some embodiments, as shown in FIGS. 2a, 2b and 7-8b, a sealing member 25 is provided between an outer periphery of the latch bolt 23 and the partition 22, and the sealing member 25 is located in the lock core area 21A, and a first end 251 of the sealing member 25 is connected to the outer periphery of the latch bolt 23, and a second end 252 of the sealing member 25 is connected to the partition 22. The sealing member 25 separates the lock core area 21A into a sealed area 21A1, which is sealed and isolated from the lock hook connection area 21B, and a non-sealed area 21A2 connected to the lock hook connection area 21B. Components such as the driving element 24 and the control circuit board 3 are arranged in the sealed area 21A1. In order to prevent the sealing member 25 from affecting the movement of the latch bolt 23, the sealing member 25 is made of elastic material that stretches and contracts with the movement of the latch bolt 23. For example, a sealing material such as rubber that is elastic and waterproof can be used. The sealing member 25 is cylindrical, and is sealingly connected to the latch bolt 23 and the partition 22 in the circumferential direction.

In the aforementioned embodiments, the sealing member 25 is provided to completely isolate the components arranged in the lock core area 21A from the moisture, thereby improving the service life of the components and improving the reliability and security of the door lock 100. In addition, the sealing member 25 connects the movable latch bolt 23 and the fixed partition 22 to form a structure similar to an airbag. The sealing member 25 stretches and contracts as the latch bolt 23 moves. When the latch bolt 23 is extended to lock, the sealing member 25 can be contracted accordingly, generating airflow away from the sealing member 25. This airflow helps discharge the moisture entering the through hole 221 through the gap between the through hole 221 and the latch bolt 23, preventing the condensation of moisture within the hole 221 that could freeze the locking latch bolt 23, thereby ensuring the smooth movement of the latch bolt 23 to the greatest extent. Optionally, the sealing member 25 is specifically a bellows-type sealing ring.

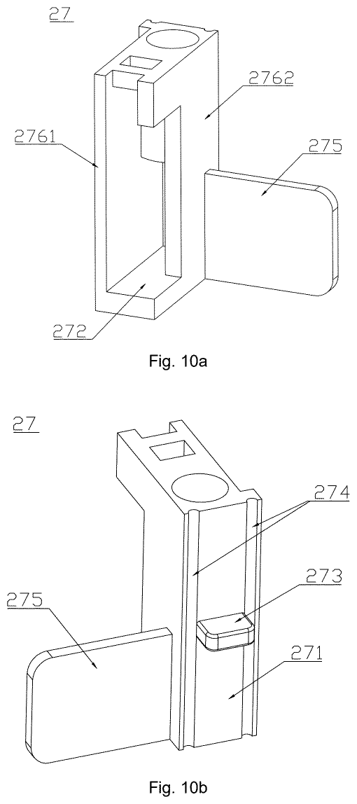

In some embodiments, as shown in FIGS. 7 and 8a-9b, the partition 22 is specifically a partition block 222, and a boss 26 is provided on the partition block 222. The boss 26 is provided with a channel 261 that runs through the boss, and the channel 261 is coaxially arranged with the through hole 221 to avoid affecting the movement of the latch bolt. The second end 252 of the sealing member 25 has a mounting part 253, and the mounting part 253 is sleeved on an outer periphery of the boss 26. The connection between the sealing member 25 and the partition 22 is achieved by sleeve connection between the mounting part 253 and the boss 26, which improves the sealing effect of the connection between the sealing member 25 and the partition 22, and ensures that the sealing member 25 completely covers the through hole 221, thereby improving the sealing effect of the sealing member 25 on the sealed area 21A1.

Furthermore, a limiting groove 262 is annularly arranged around the outer periphery of the boss 26 and close to the partition block 222, and a limiting ring 254 is provided at an end of the mounting part 253. When the mounting part 253 is sleeved on the outer periphery of the boss 26, the limiting ring 254 is snapped into the limiting groove 262. Through the snap fit between the limiting groove 262 and the limiting ring 254, the mounting part 253 is securely fixed on the boss 26, preventing the mounting part 253 from being detached from the boss 26 due to the movement of the sealing member 25 driven by the latch bolt 23 after the door lock 100 is used for a long time, thereby ensuring the stability of the connection between the sealing member 25 and the partition 22.

In the embodiment shown in FIG. 7, the main body of the mounting part 253 is flat and in surface contact with a top surface of the boss 26, thereby increasing the contact area and improving the sealing effect of the connection, so that the sealing member 25 can prevent moisture from entering for a long time. In addition, the good sealing effect also ensures that when the sealing member 25 is contracted as the latch bolt 23 moves, the moisture between the sealing member 25 and the through hole 221 can be discharged to the greatest extent, reducing the probability of the latch bolt 23 being frozen due to moisture condensation.

A deformation part 255 is provided between the first end 251 of the sealing member 25 and the mounting part 253. An outer diameter of the deformation part 255 gradually decreases in the direction away from the partition block 222. The deformation part 255 becomes flat when contracted and can be inserted into the channel 261. When the locking tongue 23 moves downward, the deformation part 255 is pressed downward, and the channel 261 provides space for the sealing member 25 to further deform downward, so that the sealing member 25 can be in a downward convex state and inserted into the channel 261, thereby sealing the through hole 221 and better preventing moisture from entering.

The deformation part 255 can be a bellows. During the compression process of the bellows, the previous section of the bellows can enter the inner side of the adjacent next section, and the bellows is ultimately compressed to a flat state. In the flat state, the sections of the bellows are sleeved one by one from inside to outside, allowing the bellows to be compressed to the greatest extent, thereby increasing the deformation capacity of the bellows and avoiding the hindrance to the extension movement of the latch bolt 23. In addition, the bellows with gradually changing outer diameter has a conical structure, providing a large internal space. As the bellows is compressed with the movement of the latch bolt 23, a significant volume change can occur rapidly, which will generate a higher internal pressure that discharges the air inside the sealing member more forcefully and quickly, further enhancing the effect of moisture discharge, and reducing the probability of the latch bolt 23 being frozen due to moisture condensation.

In some embodiments, the first end 251 of the sealing member 25 has a fixing part 256, which is annular and is snapped into a fixing groove 231 arranged on an outer wall of the latch bolt 23. Through the snap fit between the fixing groove 231 and the fixing part 256, the fixing part 256 is fixed on the latch bolt 23, ensuring the stability of the connection and the sealing effect between the latch bolt 23 and the sealing member 25. Optionally, multiple fixing grooves 231 are provided along the length direction of the latch bolt 23, providing multiple installation positions for the fixing part 256, thus enhancing the flexibility and adaptability of the installation of the sealing member 25. The good airtightness achieved by the snap fit between the fixing part 256 and the fixing groove 231 can also ensure that the sealing member 25 can discharge internal moisture to the greatest extent, reducing the probability of the latch bolt 23 being frozen due to moisture condensation.

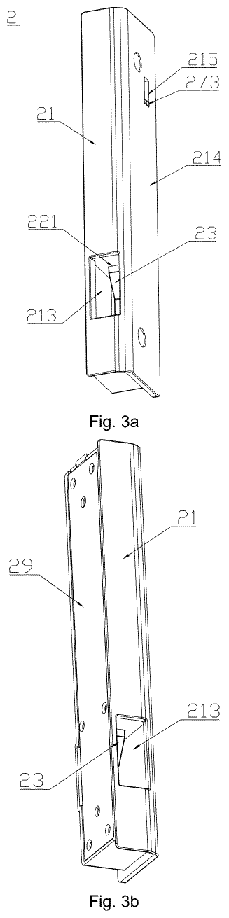

In some embodiments, a side wall of the lock housing 21 facing the storage compartment 2001 is a first side wall 214, and an operation window 215 is provided on the first side wall 214. As shown in FIGS. 3a and 4-6, a linkage member 27 is arranged in the lock core area 21A, and the linkage member 27 includes an operation panel 271 and a driving plate 272 arranged at a bottom of the operation panel 271. The operation panel 271 is pressed against an inner surface of the first side wall 214 and closes the operation window 215. A toggle block 273 is provided on the operation panel 271, and the toggle block 273 is exposed through the operation window 215. An end of the latch bolt 23 away from the lock hook connection area 21B is fixedly connected to a linkage base 28. When the latch bolt 23 is in the locked position, a linkage rod 281 arranged on the linkage base 28 rests on an upper surface of the driving plate 272. By upwardly toggling the toggle block 273, the linkage member 27 drives the linkage rod 281 to move upward through the driving plate 272, thereby driving the latch bolt 23 to retract upward to unlock.

In the aforementioned embodiments, a method of unlocking from the inside of the refrigerator body 200 of is provided. In the event that a child accidentally enters and is locked in the refrigerator, the child can manually toggle the toggle block 273 upward through the operation window 215, so as to driving the linkage member 27 to move upward. The upward movement of the linkage member 27 in turn drives the linkage base 28 with the linkage rod 281 resting thereon to move upward, thereby driving the latch bolt 23 connected to the linkage base 28 to move upward to the unlocked position. Thus, the door 300 can be opened from the inside, and the child can push and open the door 300 by himself and escape from the refrigerator.

The linkage member 27 and the linkage base 28 form a linkage structure, and this linkage structure drives the latch bolt 23 to move upward to the unlocked position only when the latch bolt 23 is in the locked position, and will not affect the normal locking and unlocking of the latch bolt 23 under the drive of the driving element 24. When the driving element 24 drives the latch bolt 23 to move to the locked position, the linkage rod 281 of the linkage base 28 is just in contact with the upper surface of the driving plate 272 of the linkage member 27. When unlocking from inside is required, the linkage member 27 will drive the latch bolt 23 to move upward. However, when unlocking from inside is not needed, the driving element 24 drives the latch bolt 23 to move upward, causing the linkage base 28 to rise upward along with the latch bolt 23 and disengage from the driving plate 272. The linkage member 27 remains stationary, preventing frequent sliding wear caused by continuous follow-up with the latch bolt 23, thereby prolonging the service life of the linkage member 27. Meanwhile, the operation panel 271 of the linkage member 27 keeps the sealing of the operation window 215.

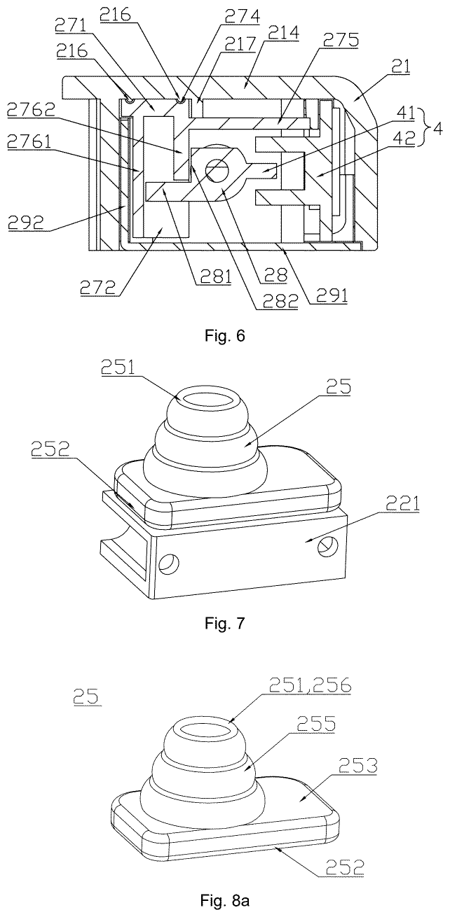

In some embodiments, as shown in FIGS. 6, 10a and-10b, a sliding groove 274 is vertically provided on a surface of the operation panel 271 and facing the first side wall 214, and a sliding rail 216 corresponding to the sliding groove 274 is provided on the first side wall 214, and the vertical movement of the linkage member 27 along with the toggle block 273 is guided by the cooperation of the sliding groove 274 and the sliding rail 216. By having the operation panel 271 in contact with first side wall 214 of the lock housing 21 and providing the sliding rail 216, the operation panel 271 is guided to slide along the first side wall 214, so that the linkage member 27 can move smoothly to unlock guided by the toggle block 273. The operation panel 271 always covers the operation window 215 during the sliding process, thereby preventing the moisture in the refrigerator from entering the lock housing 21 through the operation window 215, and thus avoiding damage to internal components.

Specifically, two pairs of sliding rails 216 and slide grooves 274 are provided, and the two sliding rails 216 are respectively located on both sides of the operation window 215, thereby forming two sealing structures on either side of the operation window 215. These sealing structures prevent moisture from entering through the gap between the operation panel 271 and the first side wall 214 of the lock housing 21, improving the sealing of the lock body 2 and preventing moisture from damaging the lock body 2, thereby ensuring stable operation of the lock body 2 when it is installed within the storage compartment 2001 and improving the anti-theft security of the refrigerator.

In some embodiments, as shown in FIG. 6, the lock body 2 further includes a cover 29 with an L-shaped cross-section. The cover 29 includes a covering part 291 and an assembly part 292. One side of the lock housing 21 away from the operation window 215 is open, and the covering part 291 closes the open side of the lock housing 21, while the assembly part 292 is in contact with an inner wall of the lock housing 21 with one end pressing the operation panel 271 against the first side wall 214, maintaining the operation panel 271 being pressed against the first side wall 214, thereby achieving positioning and sealing of the operation panel 271. In these embodiments, the lock housing 21 is open on one side, so that the latch bolt 23, the driving element 24, the linkage member 27 and other components are conveniently installed into the lock housing 21. The L-shaped cover 29 closes the lock housing 21 with the assembly part 292 extending into the lock shell 21 and is in contact with the inner wall of the lock housing 21, providing a wide contact area for better sealing of the lock shell 21. In addition, the assembly part 292 extends into the lock shell 21 to press against the operation panel 271, so that the operation panel 271 more tightly closes the operation window 215.

In some embodiments, further referring to FIG. 6, a first baffle 217 is vertically disposed on the first side wall 214 of the lock housing 21 toward the inside of the lock housing 21, and the first baffle 217 is located on the side of the operation window 215 that is away from the assembly part 292. The linkage member 27 is provided with a second baffle 275, and the second baffle 275 is parallel to the first side wall 214 and rests against the end of the first baffle 217. The two sliding rails 216 are located between the assembly part 292 and the first baffle 217. The contact between the first baffle 217 and the second baffle 275 forms an additional sealing structure, preventing moisture from entering through the operation window 215.

In some embodiments, as shown in FIGS. 5, 6 and 10a, a support plate 276 is installed between the operation panel 271 and the driving plate 272, and the support plate 276 is vertically connected to both the operation panel 271 and the driving plate 272. The support plate 276 serves as a stiffening rib to reinforce the operation panel 271 to prevent it from deforming inwards during manual operation, so that the operation panel 271 maintains sliding contact with the first inner wall and continuously closes the operation window 215 to maintain the blocking effect on moisture. Specifically, there are two support plates 276, a first support plate 2761 is in contact with the assembly part 292 of the cover body 29, and a second support plate 2762 is in contact with a matching surface 282 of the linkage base 28 and rests against a side surface of the linkage rod 281 to limit the position of the linkage member 27.

In some embodiments, the door lock 100 further includes a latch bolt position monitoring assembly 4, a temperature sensor 5, and a heating element 6 which are all connected to the processor 31. The latch bolt position monitoring assembly 4 is used to detect the position of the latch bolt 23 to determine whether the latch bolt 23 is in the locked position or the unlocked position, the temperature sensor 5 is used to detect the temperature of the latch bolt 23, and the heating element 6 is used to heat the latch bolt 23. The processor 31 is configured to: when the processor 31 controls the latch bolt 23 to move to the unlocked position, but the latch bolt position monitoring assembly 4 does not detect that the latch bolt 23 is in the unlocked position, determine whether the temperature detected by the temperature sensor 5 is lower than a preset temperature, and control the heating element 6 to heat the latch bolt 23 if the temperature detected by the temperature sensor 5 is lower than the preset temperature. Through the cooperation of the processor 31 with the temperature sensor 5 and the latch bolt position monitoring assembly 4, when the latch bolt 23 is frosted and frozen, the heating element 6 can be controlled to heat the latch bolt 23 to defrost the latch bolt 23 so as to remove the obstacle to unlocking, thereby ensuring the normal operation of the door lock 100.

If the latch bolt 23 is not frozen due to frost, after the processor 31 controls the latch bolt 23 to move to the unlocked position, the unlocked state can be normally monitored by the latch bolt position monitoring assembly 4. Therefore, when the latch bolt position monitoring assembly 4 does not detect the unlocked state signal, it can be determined that the latch bolt 23 may be frozen due to frost. In addition, according to experience, frost formation inside the refrigerator becomes noticeable at temperatures below −15° C., which may cause the latch bolt 23 to be frozen. In some embodiments, the preset temperature is set to −15° C. In some embodiments, the processor 31 can use an existing MCU chip, and the temperature sensor 5 can use an existing temperature sensor 5.

In some embodiments, as shown in FIGS. 2a, 2b and 5, the latch bolt position monitoring assembly 4 includes a light-shielding member 41 and a photoelectric sensor 42, the light-shielding member 41 is installed on the latch bolt 23 to move along with the latch bolt 23, and the photoelectric sensor 42 is arranged in the lock core area 21A. As shown in FIG. 12, the photoelectric sensor 42 is electrically connected to the processor 31, when the latch bolt 23 moves to the locked position, the light-shielding member 41 moves and enters the optical path of the photoelectric sensor 42 to interrupt the light sensing signal of the photoelectric sensor 42 as a locked state signal, when the latch bolt 23 leaves the locked position, the light-shielding member 41 moves out of the optical path of the photoelectric sensor 42 to restore the light sensing signal as an unlocked state signal. In these embodiments, the light-shielding member 41 is mounted on the linkage base 28 and moves along with the latch bolt 23.

The photoelectric sensor 42 has a transmitting end and a receiving end, where the light emitted from the transmitting end is received by the receiving end, and the photoelectric sensor 42 generates a light sensing signal. When the light-shielding member 41 moves and enters the optical path between the transmitting end and the receiving end, the receiving end is unable to receive the light emitted from the transmitting end, thereby interrupting the light sensing signal and the locked state signal is detected.

In some embodiments, as shown in FIG. 5, a light-emitting element 7 is provided in the lock body 2 and is installed near the operation panel 271. The operation panel 271 is made of transparent material. The light-emitting element 7 is connected to the processor 31, and the processor 31 is configured to: when the locked state signal is received, control the light-emitting element 7 to turn on to illuminate the operation panel 271. After the operation panel 271 is illuminated, it is more conspicuous in the refrigerator body 200. When a child is trapped in the refrigerator, the toggle block 273 on the operation panel 271 can be easily noticed. This allows for quicker access to the toggle block 273 for manual unlocking, enabling the child to escape quickly and enhancing the safety of the refrigerator.

In some embodiments, as shown in FIGS. 1a-1c, 2a and 2b, the door lock 100 further includes a door connector 8, the lock hook 1 is installed on the door connector 8, and the door connector 8 is equipped with an RFID (Radio Frequency Identification) chip 81; the control circuit board 3 is equipped with an RFID sensing module 32 that generates an induction signal with the RFID chip 81. As shown in FIG. 12, the processor 31 is electrically connected to the RFID sensing module 32, when the RFID sensing module 32 senses the RFID chip 81 and generates the induction signal, the RFID sensing module 32 outputs a locking instruction to the processor 31. The door connector 8 is installed on the door 300, and when the door 300 is closed, the door connector 8 is close to the lock body 2 installed on the refrigerator body 200, allowing the RFID sensing module 32 to sense the RFID chip 81 and sends the locking instruction to the processor 31. It should be noted that the use of the RFID chip 81 to control the locking instruction is an existing technology used by the smart vending refrigerator, and the specific working process will not be repeated here.

In some embodiments, referring to FIGS. 2a and 2b, in order to ensure that the lock hook is in place, the door lock 100 also includes a lock hook in place monitoring assembly 9, and the lock hook in place monitoring assembly 9 includes a magnet 91 and a magnetic sensor 92. The magnet 91 is arranged in the lock hook 1, and the magnetic sensor 92 is arranged in the lock core area 21A. As shown in FIG. 12, the magnetic sensor 92 is electrically connected to the processor 31, when the lock hook 1 extends into the lock hook connection area 21B, the magnetic sensor 92 and the magnet 91 are close to each other to generate a magnetic induction signal as a lock hook in place signal. When the lock hook 1 leaves the lock hook connection area 21B, the magnetic sensor 92 and the magnet 91 are away from each other, causing the magnetic induction signal to disappear. The processor 31 is configured to: when receiving a locking instruction, determine whether the photoelectric sensor 42 detects the locked state signal, and whether the magnetic sensor 92 detects the lock hook in place signal; if the processor 31 receives the locked state signal from the photoelectric sensor 42, and the lock hook in place signal from the magnetic sensor 92, it is determined that the door lock 100 has been locked in place, otherwise, it is determined that the door lock 100 is not locked; when it is determined that the door lock 100 is not locked, the processor 31 issues an alarm. In these embodiments, the latch bolt position monitoring assembly 4 can monitor whether the latch bolt 23 reaches the locked position, and the lock hook in place monitoring assembly 9 can monitor whether the lock hook 1 is extended in place, and the two cooperate to ensure that the door lock 100 is locked in place.

In some embodiments, the driving element 24 includes an electromagnet 241, and the latch bolt 23 is sleeved inside the electromagnet 241; the processor 31 is electrically connected to a coil 242 of the electromagnet 241, and the processor 31 is configured to: control the coil 242 to be energized when receiving an unlocking instruction, so as to drive the latch bolt 23 moves to the unlocked position under the magnetic force generated by the energized coil 242; control the coil 242 to be de-energized when receiving a locking instruction, so as to the latch bolt 23 moves to the locked position.

In some embodiments, the heating element 6 is the coil 242 of the above-mentioned electromagnet 241, and the processor 31 is configured to: increase an output PWM duty cycle to increase current in the coil 242 when the temperature detected by the temperature sensor 5 is determined to be below the preset temperature, so as to heat the latch bolt 23.

The working principle of the electromagnet 241 is that the energized coil generates magnetic attraction, and the magnetic force drives the iron latch bolt 23 to move. The greater the current, the stronger the magnetic force generated. In the aforementioned embodiments, if the latch bolt 23 fails to move, the increased current in the coil 242 will generate eddy currents in the coil and thus will generate a large amount of heat, which can be conducted to the frozen part of the latch bolt 23 through the electromagnet 241 to achieve the defrosting effect. Therefore, in these embodiments, the coil 242 of the electromagnet 241 is used both to control the movement of the latch bolt 23 through electromagnetic action and to heat the latch bolt 23 when it is frozen, without the need for other heating elements set separately. Since the coil 242 of the electromagnet 241 has a maximum operating temperature, if the temperature is monitored to exceed the maximum operating temperature, the defrosting operation is suspended, and after the electromagnet 241 returns to the normal operating temperature, the defrosting operation is restarted until the latch bolt 23 is fully thawed.

In addition, increasing the current of the coil 242 will also increase the magnetic force generated by electromagnet 241, so that the latch bolt 23 is subjected to a greater driving force. To a certain extent, the greater driving force overcomes the resistance caused by moisture condensation acting on the latch bolt 23. As a result, when the moisture defrosts and the resistance is slightly decreased, the latch bolt 23 can overcome the frozen resistance and move to the unlocked position, thereby improving the efficiency of thawing and unlocking of the latch bolt 23.

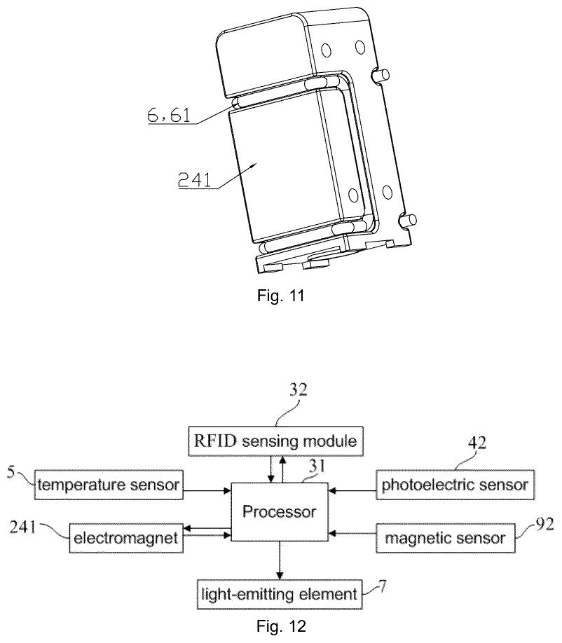

In other embodiments, as shown in FIG. 11, the heating element 6 includes a heating wire 61 wound around the electromagnet 241, and the processor 31 is configured to: control the heating wire 61 to be energized when the temperature detected by the temperature sensor 5 is determined to be below the preset temperature, so as to heat the latch bolt 23. In these embodiments, a heating wire provided separately is used as the heating element 6, so as to facilitate heating the latch bolt 23 and avoid the maximum operating temperature limit in case that the coil of electromagnet 241 is used as the heating element 6. It should be noted that in order to facilitate the installation of the heating wire 61, in some embodiments, an outer surface of the electromagnet 241 is provided with a groove for the heating wire 61 to be embedded.

A second aspect of the present application provides a refrigerator. As shown in FIG. 13, the refrigerator includes a refrigerator body 200 and a door 300 disposed on the refrigerator body 200, a storage compartment 2001 is defined inside the refrigerator body 200, and a door lock 100 as described in any one of the aforementioned embodiments of the first aspect is arranged between the refrigerator body 200 and the door 300. The lock body 2 is installed on the refrigerator body 200 and is located on an inner wall of the refrigerator body 200 facing the storage compartment 2001, and the lock hook 1 is correspondingly installed on the door 300.

Goods are placed in the storage compartment 2001 inside the refrigerator body 200. The door 300 can be opened to put the goods into or take them out of the storage compartment 2001. Goods can be either placed into or taken out from the storage compartment 2001 when opening the door 300, while goods are locked inside the storage compartment 2001 when closing the door 300. When the door 300 is closed, the lock hook 1 installed on the door 300 locks with the latch bolt 23 extending into the lock hook connection area 21B in the lock body 2, preventing the door 300 from opening, thereby the door 300 is locked, ensuring that the cabinet door 300 remains closed and keeps the storage compartment 2001 enclosed. When the door needs to be opened, the latch bolt 23 retracts from the lock hook connection area 21B to release the lock with the lock hook 1, and enables the door 300 to open.

The lock body 2 is arranged in the storage compartment 2001 for storing goods. After the door 300 closes the storage compartment 2001 and is locked, the lock body 2 is also locked in the storage compartment 2001 to prevent the lock body 2 from being exposed outside, making it difficult to be damaged, thereby improving the security of the goods in the refrigerator.

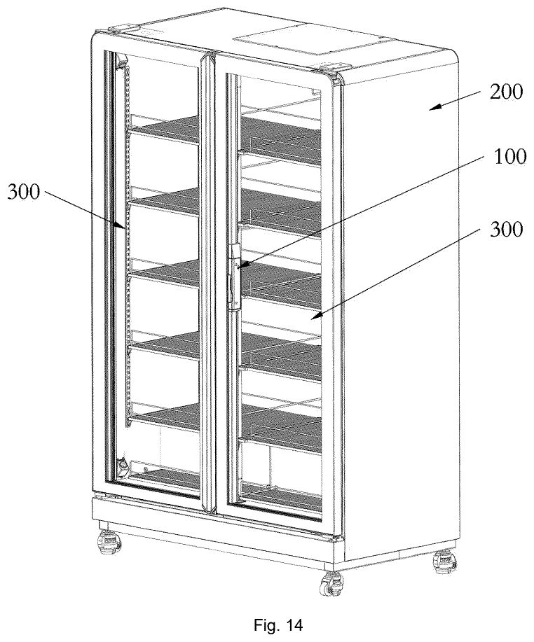

In some embodiments, as shown in FIG. 14, the refrigerator may be a double-door structure, which has two doors 300 installed side by side, two door locks 100 are installed on the refrigerator body 200 corresponding to the two doors, respectively.

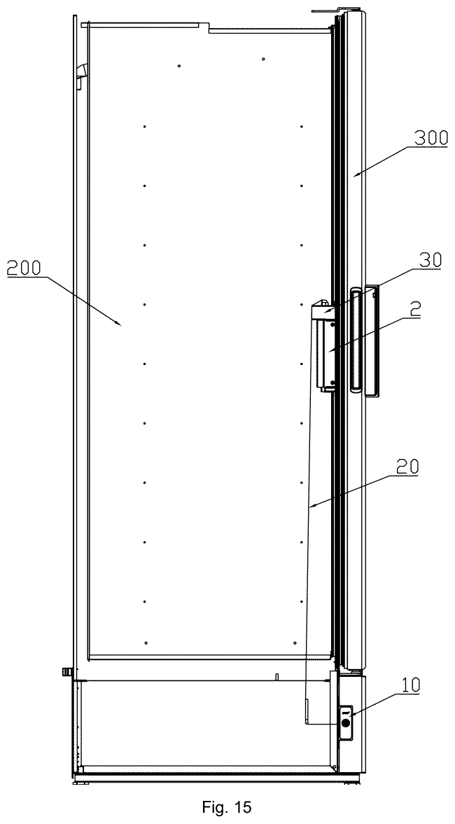

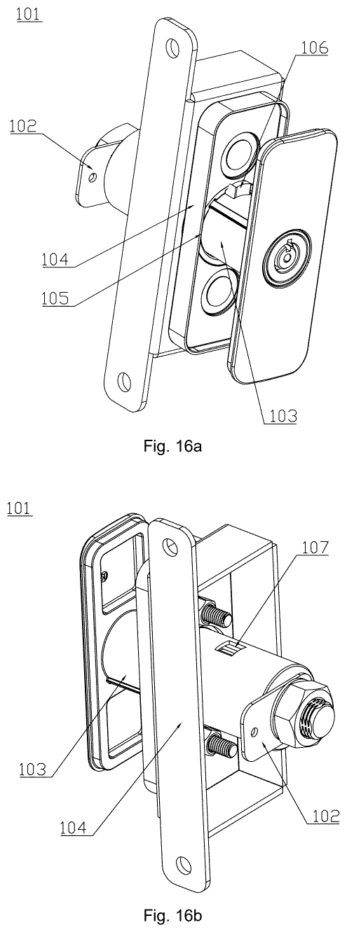

In some embodiments, as shown in FIG. 15, an external lock 10 is installed on an outer side of the refrigerator body 200, and the external lock 10 is connected to the linkage member 27 via a lock wire 20 and is configured to drive the linkage member 27 to move and pull the latch bolt 23 from the locked position to the unlocked position through the lock wire 20 when the external lock 10 is manually operated, thereby releasing the lock of the door 300. In the event that a child accidentally enters and is locked in the refrigerator or the door lock 100 fails, an external person can operate the external lock 10 outside the refrigerator, thereby driving the linkage member 27 to move through the lock wire 20, and the linkage member 27 moves and then pulls the latch bolt 23 connected thereto to the unlocked position, thereby unlocking the door 300. Thus, the door 300 can be opened from the outside, and the child can escape from the refrigerator by unlocking from the outside. In this way, the refrigerator not only has higher security in terms of anti-theft but also has relatively high safety in terms of personal protection.

In some embodiments, the external lock 10 is a T-shaped lock 101 installed on the outer side of the refrigerator body 200, as shown in FIGS. 16a and 16b. The T-shaped lock 101 has a swing rod 102 that can rotate along with a lock cylinder 103 of the T-shaped lock, and the swing rod 102 is fixedly connected to the lock wire 20.

The lock cylinder 103 of the T-shaped lock is inserted into a mounting hole 105 of a housing 104 of the T-shaped lock, and a latch bolt 106 of the external lock 10 extending from the lock cylinder 103 is inserted into a lock hole 107 of external lock 10 on an inner wall of the mounting hole 105. When no key is inserted, the lock cylinder 103 of the T-shaped lock is locked and cannot rotate. After the key is inserted into the keyhole, the key can rotate the lock cylinder 103 to pull the latch bolt 106 of the external lock 10 out of the lock hole 107. The lock cylinder 103 of the T-shaped lock, with the restriction released, extends outward under the action of an installed spring or can be manually pulled out. Since the lock cylinder has a T-shaped appearance, an outer end thereof designed as a handle, which can be rotated manually. The swing rod 102 fixedly connected to the lock cylinder 103 rotates accordingly, pulling the lock wire 20 connected thereto, which in turn pulls the linkage member 27. After manually unlocking the refrigerator, the lock cylinder 103 is pushed back, and the latch bolt 106 snaps into the lock hole 107 of the external lock 10 on the inner wall of the mounting hole 105, completing the locking of the T-shaped lock 101.

The T-shaped lock 101 is a mechanical lock that is operated using a key. In the prior art, it is generally installed on the door 300. When the door 300 is closed, the swing rod 102 is rotated and extended to the inner side of the edge of the opening 2002 of the refrigerator body 200, so that the edge of the opening 2002 blocks the swing rod 102 from moving forward, thereby locking the door 300 in a closed state. In the present application, the T-shaped lock is used as an external lock 10 to pull the lock wire 20 for unlocking, and it has an anti-theft effect that can only be operated by a key, which not only enables emergency unlocking of the refrigerator from the outside but also prevents the external lock 10 from being maliciously operated to cause the door 300 to be unlocked and the goods in the refrigerator to be lost.

In addition, since the external lock 10 and the linkage member 27 are connected by the lock wire 20, the two are far apart and may not be aligned in a straight line. The lock wire 20 may need to change direction when connecting the external lock 10 and the linkage member 27. After the lock cylinder 103 of the T-shaped lock is pulled out or ejected, it forms a handle-like structure. Manual rotation acted on the lock cylinder 103 can generate a large torque, which may overcome the resistance caused by the bending of the lock wire 20. Thus, the lock wire 20 can be easily turned and pulled to drive the latch bolt 23 to unlock. Furthermore, the swing rod 102 and the lock wire 20 are in the same plane, preventing an increase in resistance caused by more directional changes in the lock wire 20 when pulling the lock cylinder 103 of the external lock 10 outward.

It can be understood that the T-shaped lock 101 can be replaced by other mechanical locks that can only operate when a key is inserted. The component connecting the lock wire 20 can be a reel, which winds or releases the lock wire 20 as the lock cylinder 103 rotates. The component connecting the lock wire 20 can also be a retractable part driven by the lock cylinder, that is, the latch bolt 106 of the mechanical lock is used as the retractable part. When the key is inserted and turned, the latch bolt 106 is retracted into the lock cylinder 103, thereby pulling the connected lock wire 20.

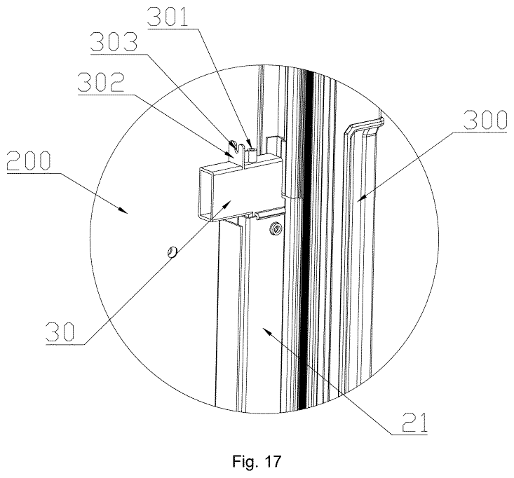

In some embodiments, one end of the lock housing 21 is provided with an outlet hole 218 and is fixedly connected to a junction box 30. As shown in FIG. 17, the junction box 30 is mounted on the top of the lock body 2, and the end of the junction box 30 away from the door 300 is open. The side of the junction box 30 away from the lock housing 21 has a wire hole 301 vertically aligned with the outlet hole 218, and a wire holder 302 is provided on an outer wall of the junction box 30, and the wire holder 302 is located on the side of the wire hole 301 away from the door 300, and has a wire groove 303. The lock wire 20 extends out of the lock housing 21 through the outlet hole 218, then further passes through the wire hole 301, bends to one side and enters the wire groove 303. The lock wire 20 enters the junction box 30 after passing through the outlet hole 218, then passes through the wire hole 301 in a straight state and extends out of the junction box 30, then bents and is supported by the wire groove 303 on the outside of the junction box 30, and is finally connected to the external lock 10. This arrangement keeps the lock wire 20 away from other cables, avoiding tangle that could occur if the lock wire 20 were to enter the junction box 30 along with other cables, ensuring smooth movement of the lock wire 20, and avoiding other cables being cut by the lock wire 20.

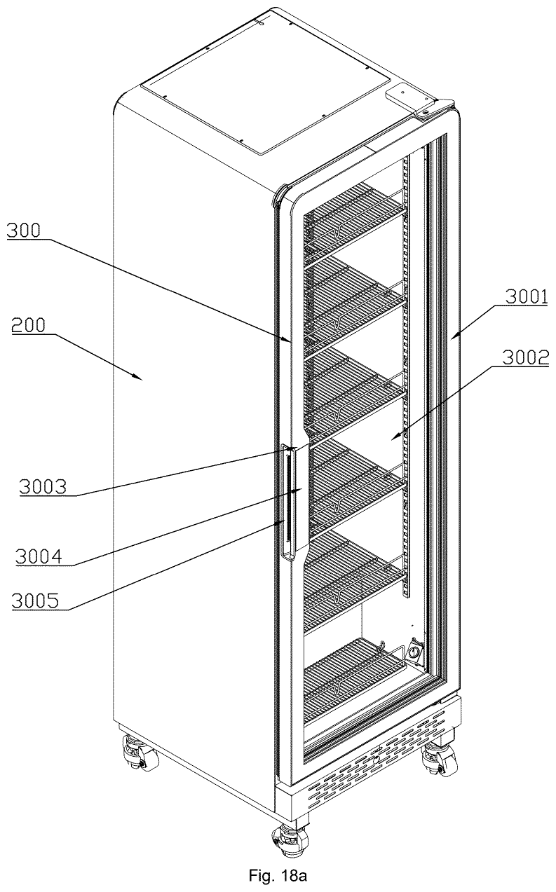

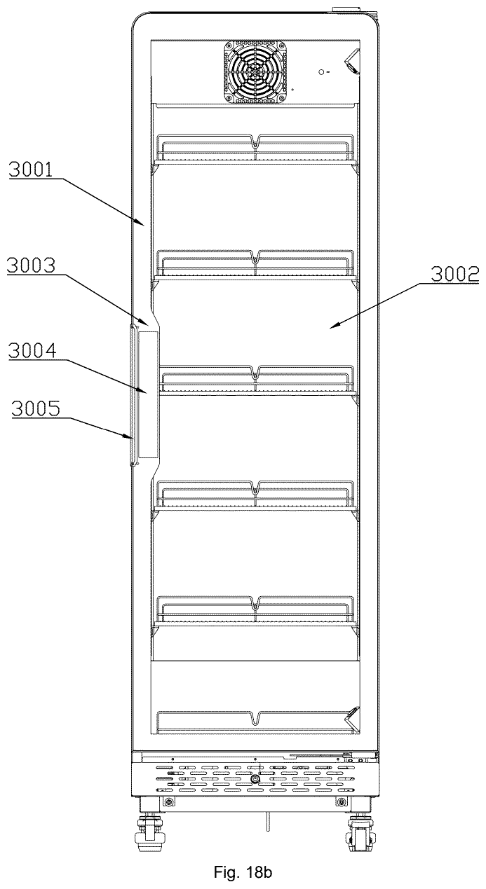

In some embodiments, as shown in FIGS. 18a to 18c, the door 300 includes a door frame 3001, a viewing window 3002, and a shielding part 3003; the shielding part 3003 is arranged on the door frame 3001 and extends toward the viewing window 3002; the shielding part 3003 shields the lock body 2 at the front of the refrigerator. When the door 300 is closed on the refrigerator body 200, the lock body 2 is shielded by the shielding part 3003, which prevents tools from accessing the lock body 2 and preventing external person from damaging the lock body 2 by violence or technical means, thereby further enhancing the anti-theft effect.

In some embodiments, the shielding part 3003 is rectangular, and the length direction of the shielding part 3003 is the same as the length direction of the door 300, that is, the length direction of the shielding part 3003 is vertically arranged, while the width direction of the shielding part 3003 extends toward the viewing window 3002. Optionally, the shielding part 3003 is integrally formed with the door frame 3001 to improve the strength and facilitate production.

In some embodiments, the refrigerator further includes a control panel 3004, and the control panel 3004 is disposed on the shielding part 3003. By arranging the control panel 3004 on the shielding part 3003, there is no need to increase the width of the door frame 3001 additionally for the control panel, thereby improving the utilization rate of the shielding part 3003, ensuring enough area of the viewing window 3002, reducing the shielding of the interior of the refrigerator body 200, and making it more convenient for users to observe the goods inside the refrigerator body 200.

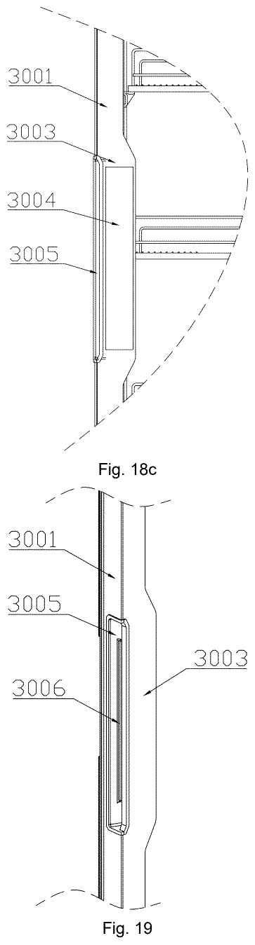

In some embodiments, as shown in FIG. 19, the door 300 is recessed inwardly to form a recessed handle 3005, and a light strip 3006 is arranged inside the recessed handle 3005 for illumination. The recessed handle 3005 on the door 300 not only serves the function of conveniently opening the door 300, but also accommodates a light strip 3006 inside. When the light strip 3006 is turned on, it provides illumination for the refrigerator, so that the items inside the refrigerator can be clearly seen at night or in a dark environment, which is convenient for the user to find the handle and pull it to open the refrigerator.

1. A door lock, comprising:
a lock hook; and
a lock body, the lock body comprising a lock housing and a partition provided inside the lock housing, the partition divides an internal space of the lock housing into a lock core area and a lock hook connection area, a through hole connecting the lock core area and the lock hook connection area is formed on the partition; a lock opening connected to the lock hook connection area is formed on the lock housing, allowing the lock hook to extend into or retract from the lock hook connection area; a latch bolt and a driving element are provided in the lock core area, and the driving element is configured to drive the latch bolt to perform a linear reciprocating motion between a locked position and an unlocked position.

2. The door lock according to claim 1, wherein a sealing member is provided between an outer periphery of the latch bolt and the partition, the sealing member is located in the lock core area, a first end of the sealing member is connected to the outer periphery of the latch bolt, and a second end of the sealing member is connected to the partition; the sealing member separates the lock core area into a sealed area, which is sealed and isolated from the lock hook connection area, and a non-sealed area connected to the lock hook connection area, the driving element is located in the sealed area, and the sealing member is made of elastic material that stretches and contracts with the movement of the latch bolt.

3. The door lock according to claim 2, wherein the partition is a partition block, a boss is disposed on the partition block, and the boss is provided with a channel that runs through the boss, the channel is coaxially arranged with the through hole, a limiting groove is annularly arranged around an outer periphery of the boss and close to the partition block, the second end of the sealing member has a mounting part, a limiting ring is provided at an end of the mounting part, the mounting part is sleeved on the boss, and the limiting ring is snapped into the limiting groove.

4. The door lock according to claim 3, wherein a deformation part is provided between the first end of the sealing member and the mounting part, an outer diameter of the deformation part decreases in a direction away from the partition block, and the deformation part becomes flat and is capable of being inserted into the channel when contracted.

5. The door lock according to claim 1, wherein a side wall of the lock housing facing the storage compartment is a first side wall, and an operation window is formed on the first side wall; a linkage member is arranged in the lock core area, the linkage member comprises an operation panel and a driving plate arranged at a bottom of the operation panel, the operation panel is pressed against an inner surface of the first side wall and closes the operation window; a toggle block is provided on the operation panel, and the toggle block is exposed through the operation window; an end of the latch bolt away from the lock hook connection area is fixedly connected to a linkage base, when the latch bolt is in the locked position, a linkage rod arranged on the linkage base rests on an upper surface of the driving plate, by toggling the toggle block upward, the linkage member drives the linkage rod to move upward through the driving plate, and thereby driving the latch bolt to retract upward to unlock.

6. The door lock according to claim 5, wherein a sliding groove is vertically provided on the operation panel and facing the first side wall, and a sliding rail corresponding to the sliding groove is provided on the first side wall, and the linkage member is guided to move vertically along with the toggle block through cooperation of the sliding groove and the sliding rail.

7. The door lock according to claim 6, wherein the lock body further comprises a cover with an L-shaped cross-section, the cover comprises a covering part and an assembly part, the lock housing is open on a side away from the operation window, the covering part closes the open side of the lock housing, while the assembly part is in contact with an inner wall of the lock housing with one end pressing the operation panel against the first side wall.

8. The door lock according to claim 1, wherein further comprises a control circuit board, the control circuit board is equipped with a processor, and the processor is electrically connected to the driving element; the processor is configured to: when receiving a locking instruction, control the driving element to drive one end of the latch bolt to extend into the lock hook connection area through the through hole to lock with the lock hook; when receiving an unlocking instruction, control the driving element to drive the latch bolt to retract back into the lock core area to unlock.

9. The door lock according to claim 8, wherein further comprises a latch bolt position monitoring assembly, a temperature sensor and a heating element which are connected to the processor, the latch bolt position monitoring assembly is configured to detect position of the latch bolt to determine whether the latch bolt is in the locked position or the unlocked position, the temperature sensor is configured to detect temperature of the latch bolt, and the heating element is configured to heat the latch bolt, and the processor is configured to: when the processor controls the latch bolt to move to the unlock position but the latch bolt position monitoring assembly does not detect that the latch bolt is in the unlocked position, determine whether the temperature detected by the temperature sensor is lower than a preset temperature, and control the heating element to heat the latch bolt if the temperature detected by the temperature sensor is lower than the preset temperature.

10. The door lock according to claim 9, wherein the latch bolt position monitoring assembly comprises a light-shielding member and a photoelectric sensor, the light-shielding member is installed on the latch bolt to move along with the latch bolt, the photoelectric sensor is arranged in the lock core area and electrically connected to the processor; when the latch bolt moves to the locked position, the light-shielding member moves and enters an optical path of the photoelectric sensor to interrupt a light sensing signal of the photoelectric sensor as a locked state signal; when the latch bolt leaves the locked position, the light-shielding member moves out of the optical path of the photoelectric sensor to restore the light sensing signal as an unlocked state signal.

11. The door lock according to claim 9, wherein further comprises a door connector, the lock hook is installed on the door connector, and the door connector is equipped with an RFID chip; the control circuit board is equipped with an RFID sensing module that generates an induction signal with the RFID chip, and the processor is electrically connected to the RFID sensing module; when the RFID sensing module senses the RFID chip and generates the induction signal, the RFID sensing module outputs the locking instruction to the processor.

12. The door lock according to claim 11, wherein further comprises a lock hook in place monitoring assembly, the lock hook in place monitoring assembly comprises a magnet and a magnetic sensor, the magnet is arranged in the lock hook, the magnetic sensor is arranged in the lock core area, and the magnetic sensor is electrically connected to the processor; when the lock hook extends into the lock hook connection area, the magnetic sensor and the magnet are close to each other to generate a magnetic induction signal as a lock hook in place signal; when the lock hook leaves the lock hook connection area, the magnetic sensor and the magnet are away from each other, causing the magnetic induction signal to disappear; the processor is configured to: when receiving the locking instruction, determine whether the photoelectric sensor detects the locked state signal and whether the magnetic sensor detects the lock hook in place signal; if the processor receives the locked state signal from the photoelectric sensor and the lock hook in place signal from the magnetic sensor, it is determined that the lock has been locked in place, otherwise, it is determined that the lock door is not locked; when it is determined that the lock door is not locked, the processor issues an alarm.

13. The door lock according to claim 12, wherein the driving element comprises an electromagnet, and the latch bolt is sleeved inside the electromagnet; the processor is electrically connected to a coil of the electromagnet, and the processor is configured to: control the coil to be energized when receiving an unlocking instruction, so as to drive the latch bolt moves to the unlocked position under magnetic force generated by the coil being energized, and control the coil to be de-energized when receiving a locking instruction, so as to drive the latch bolt moves to the locked position.

14. The door lock according to claim 13, wherein the heating element is the coil, and the processor is configured to: increase an output PWM duty cycle to increase current in the coil when the temperature detected by the temperature sensor is determined to be below the preset temperature, so as to heat the latch bolt.

15. The door lock according to claim 13, wherein the heating element comprises a heating wire wound around the electromagnet, and the processor is configured to: control the heating wire to be energized when the temperature detected by the temperature sensor is determined to be below the preset temperature, so as to heat the latch bolt.

16. A refrigerator, comprising a refrigerator body and a door disposed on the refrigerator body, a storage compartment is defined inside the refrigerator body, and a door lock according to claim 1 is arranged between the refrigerator body and the door, wherein the lock body is installed on the refrigerator body and is located on an inner wall of the refrigerator body facing the storage compartment, and the lock hook is correspondingly installed on the door.

17. The refrigerator according to claim 16, wherein a linkage member is slidably installed in the lock housing of the lock body, the linkage member is linked with the latch bolt to drive the latch bolt to move from the locked position to the unlocked position, an external lock is installed on an outer side of the refrigerator body, and the external lock is connected to the linkage member through a lock wire and is configured to drive the linkage member to move and pull the latch bolt from the locked position to the unlocked position through the lock wire when the external lock is manually operated, thereby releasing lock on the door.

18. The refrigerator according to claim 17, wherein the external lock is a T-shaped lock installed on the refrigerator body, the T-shaped lock has a swing rod that rotate along with a lock cylinder of the T-shaped lock, the swing rod is fixedly connected to the lock wire, and the lock wire is driven to move by rotating the swing rod of the T-shaped lock.

19. The refrigerator according to claim 18, wherein one end of the lock housing is provided with an outlet hole and is fixedly connected to a junction box, an end of the junction box away from the door is open, a side of the junction box away from the lock housing has a wire hole aligned with the outlet hole, and a wire holder is provided on an outer wall of the junction box, the wire holder is located on a side of the wire hole away from the door and is provided with a wire groove, the lock wire extends out of the lock housing through the outlet hole, further passes through the wire hole, and bends to one side to enter the wire groove.

20. The refrigerator according to claim 16, wherein the door comprises a door frame, a viewing window and a shielding part, the shielding part is arranged on the door frame and extends toward the viewing window to shield the lock body at front of the refrigerator, and a control panel is arranged on the shielding part.
